(19) United States
(12) Patent Application Publication
(10) Pub. No.: US 2021/0337192 A1
(43) Pub. Date: Oct. 28, 2021

(54) IMAGE PROCESSING METHOD AND ASSOCIATED ENCODER

(71) Applicant: Realtek Semiconductor Corp., HsinChu (TW)

(72) Inventors: Weimin Zeng, MILPITAS, CA (US); Chi-Wang Chai, Cupertino, CA (US); Wujun Chen, Suzhou City, Jiangsu Province (CN); Jing Wang, Suzhou City (CN); Rong Zhang, Suzhou City (CN)

(21) Appl. No.: 16/857,187

(22) Filed: Apr. 24, 2020

(51) Int. Cl. H04N 19/117; H04N 19/176; H04N 19/573; H04N 19/139

(52) U.S. Cl. CPC H04N 19/117; H04N 19/139; H04N 19/573; H04N 19/176

(57) ABSTRACT

An image processing method includes: determining a first block and a second block corresponding to a current block; dividing each of the current block, the first block and the second block into a plurality of clusters; for a cluster having a corresponding location within each of the current block, the first block and the second block, performing gradient calculations on pixel values within the cluster of the first block and pixel values within the cluster of the second block, and accordingly determining an adjustment value, wherein a window size of the cluster used in the gradient calculations is one or zero; and for a pixel within the cluster of the current block, referring to a pixel value of the pixel of the first block, a pixel value of the pixel of the second block and the adjustment value to calculate a pixel value of the pixel of the current block.

### BACKGROUND OF THE INVENTION

### 1. Field of the Invention

The present invention is related to image processing methods, and more particularly, to an image encoding method that involves bi-directional optical flow (BIO) calculations.

### 2. Description of the Prior Art

Video encoding/decoding involves compression (and decompression) of digital video signals. Examples of video encoding/decoding specifications comprise H.264 video compression specification and High Efficiency Video Coding (HEVC) thereafter. The purpose of video encoding is video compression, and the video encoding adopts prediction, conversion, quantization and entropy encoding to reduce redundancy within video data as much as possible, and use as little data as possible for presenting video contents. Bi-directional optical flow (BIO) is a technology for the video encoding prediction part, which uses pixel values of two reference blocks (e.g., forward and backward blocks) corresponding to a current block to predict and obtain pixel values of the current block. However, conventional BIO algorithms may need to implement a greater buffer circuit since a larger window and more taps of filter is required, and thereby increase hardware costs.

### SUMMARY OF THE INVENTION

Thus, an objective of the present invention is to provide an image processing method that merely needs to implement a smaller buffer circuit for completing a bi-directional optical flow (BIO) algorithm, to solve the problem of the related art.

In one embodiment of the present invention, an image processing method is disclosed. The image processing method comprises the steps of: for a current block within a current frame, determining a first block within a first frame and a second block within a second frame, wherein the first frame and the second frame are adjacent to the current frame; dividing each of the current block, the first block and the second block into a plurality of clusters; for a cluster having a corresponding location within each of the current block, the first block and the second block, performing gradient calculations on pixel values within the cluster of the first block and pixel values within the cluster of the second block, and accordingly determining an adjustment value, wherein a window size surrounding the cluster used in the gradient calculations is one or zero; and for a pixel within the cluster within each of the current block, the first block and the second block, referring to a pixel value of the pixel of the first block, a pixel value of the pixel of the second block and the adjustment value to calculate a pixel value of the pixel of the current block.

In another embodiment of the present invention, an encoder is disclosed. The encoder comprises a receiving circuit, an adjustment value calculating circuit and a pixel value calculating circuit. In operations of the encoder, the receiving circuit is configured to receive a first frame and a second frame; for a current block within a current frame, the adjustment value calculating circuit determines a first block within the first frame and a second block within the second frame, and divides each of the current block, the first block and the second block into a plurality of clusters; for a cluster having a corresponding location within each of the current block, the first block and the second block, the adjustment value calculating circuit performs gradient calculations on pixel values within the cluster of the first block and pixel values within the cluster of the second block, and accordingly determines an adjustment value, wherein a window size surrounding the cluster used in the gradient calculations is one or zero; and for a pixel within the cluster within each of the current block, the first block and the second block, the pixel value calculating circuit refers to a pixel value of the pixel of the first block, a pixel value of the pixel of the second block and the adjustment value to calculate a pixel value of the pixel of the current block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an image processing device according to an embodiment of the present invention.

FIG. 2 is a diagram illustrating a bi-directional optical flow (BIO) algorithm.

FIG. 3 is a diagram illustrating a block being divided into four clusters.

FIG. 4 is a diagram illustrating utilizing a filter to perform gradient calculations on a first cluster.

FIG. 5 is a diagram illustrating the first cluster being added with a window having a size “1”.

FIG. 6 is a flowchart illustrating an image processing method according to an embodiment of the present invention.

### DETAILED DESCRIPTION

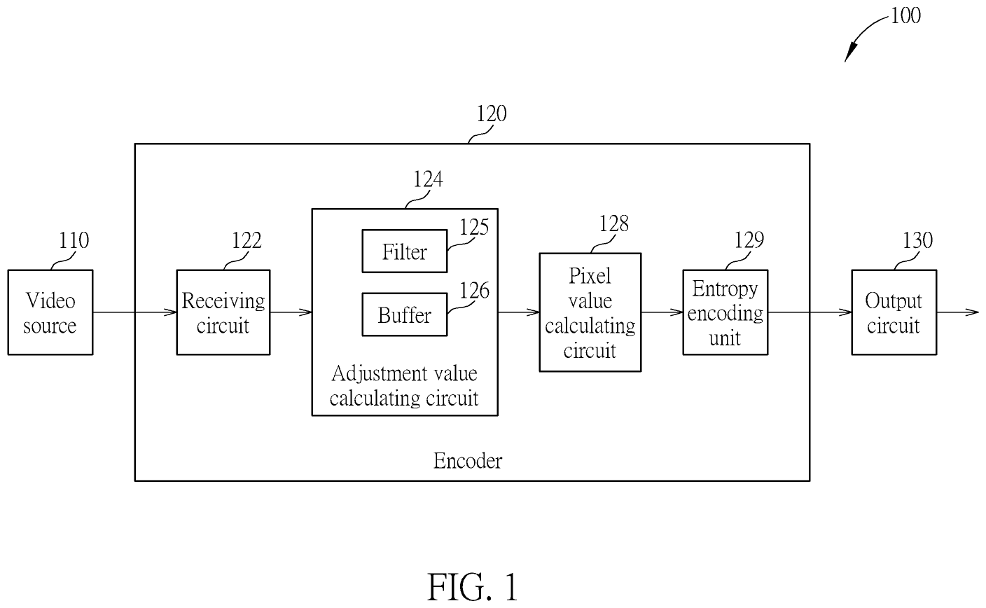

FIG. 1 is a diagram illustrating an image processing device 100 according to an embodiment of the present invention. As shown in FIG. 1, the image processing device 100 comprises a video source 110, an encoder 120 and an output circuit 130, where the encoder 120 comprises a receiving circuit 122, an adjustment value calculating circuit 124, a pixel value calculating circuit 128, and a quantization and entropy encoding unit 129, and the adjustment value calculating circuit 124 comprises a filter 125 and a buffer 126.

In this embodiment, the image processing device 100 may be included in a desktop computer, a laptop computer, a tablet, a set-top box, a television, a camera, a display device, a digital media player, or any electronic device that requires to encode/decode images. The video source 110 may be a camera, a video file, or any device that is capable of instantly or non-instantly providing video/image information. The encoder 120 is configured to encode image data provided by the video source 110, to generate encoded image data. The output circuit 130 is configured to transmit the encoded image data into a display unit (not shown) for being decoded and displayed thereon. In this embodiment, the encoder adopts a bi-directional optical flow (BIO) algorithm to encode the image data. As the main feature of the present invention is the portion of the adjustment value calculating circuit 124, the following descriptions are illustrated regarding the adjustment value calculating circuit 124.

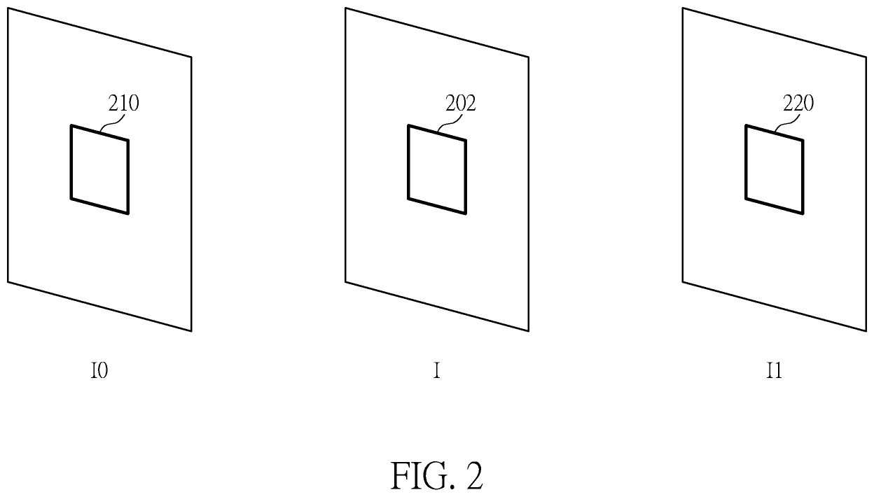

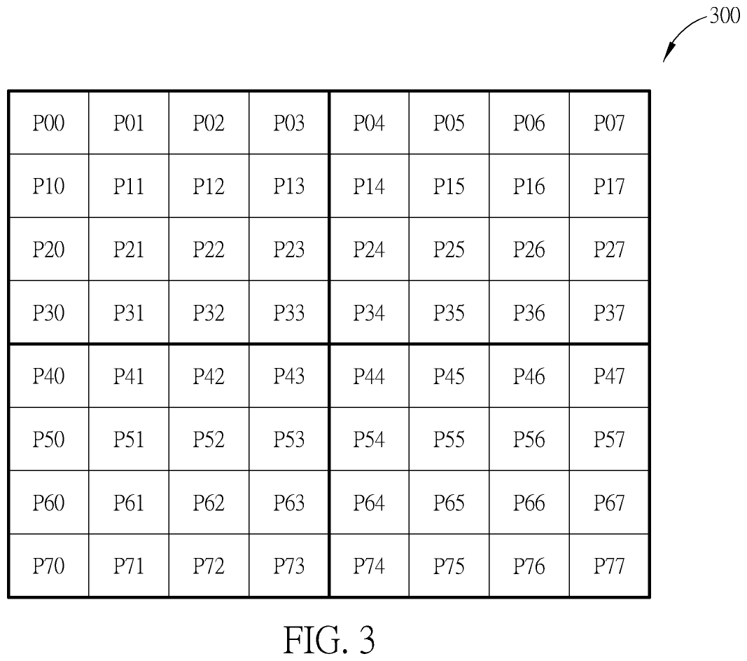

Please refer to FIG. 2, which is a diagram illustrating a BIO algorithm. As shown in FIG. 2, assuming that the receiving circuit 122 of the encoder 120 receives a first frame I0 and a second frame I1 from the video source 110 and needs to predict a current frame I, for a current block 202 within the current frame I, the adjustment value calculating circuit 124 determines a first block 210 within the first frame I0 and a second block 220 within the second frame I1, where the first frame I0 may be regarded as a forward frame of the current frame I, and second frame I1 may be regarded as a backward frame of the current frame I, and the current block 202, the first block 210 and the second block 220 have corresponding motion vectors in the process of encoding. For a purpose of reducing a calculation amount, the adjustment value calculating circuit 124 then divides each of the current block 202, the first block 210 and the second block 220 into a plurality of clusters. Take a block 300 shown in FIG. 3 as an example for illustration, where the block 300 may be configured to represent any of the current block 202, the first block 210 and the second block 220. In this embodiment, the block 300 comprises 8*8 pixels P00 to P77, and the adjustment value calculating circuit 124 may divide the block 300 into four clusters, where each cluster comprises 4*4 pixels, e.g. a first cluster comprising the pixels P00 to P33, a second cluster comprising the pixels P04 to P37, a third cluster comprising the pixels P40 to P73 and a fourth cluster comprising the pixels P44 to P77. In addition, for a cluster (e.g. the cluster comprising the pixels P00 to P33) having a corresponding location within each of the current block 202, the first block 210 and the second block 220, the adjustment value calculating circuit 124 performs gradient calculations on pixel values (e.g. brightness values) of the pixels P00 to P33 within the cluster of the first block 210 and pixel values (e.g. brightness values) of the pixels P00 to P33 within the cluster of the second block 220, and accordingly determines an adjustment value. Note that, in another embodiment, the size of each of the current block 202, the first block 210 and the second block 220 could be 4M*4N pixels. Each of the current block 202, the first block 210 and the second block 220 comprises M*N clusters, wherein the M and N are positive integer. For example, the M and N could be any integer between 1 and 32.

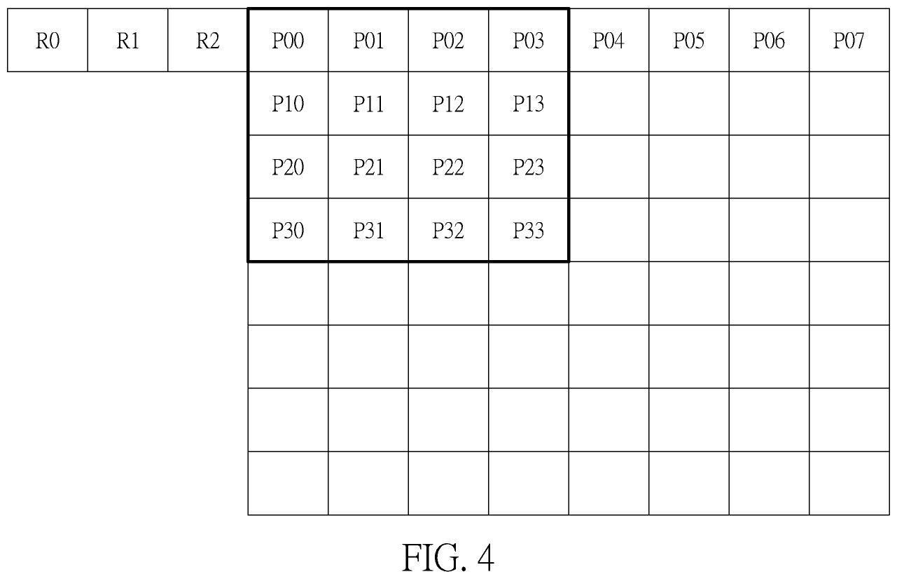

More specifically, taking the first cluster comprising the pixels P00 to P33 for illustration, the filter 125 within the adjustment value calculating circuit 124 may sequentially perform the gradient calculations on each pixel value within the first block 210 to generate a gradient value of the aforementioned each pixel, and the adjustment value calculating circuit 124 further performs calculation on the gradient value of the aforementioned each pixel to generate the adjustment value. Taking FIG. 4 as an example for illustration, assume that a tap count of the filter 125 is “eight”, and tap coefficients of the filter 125 are {−4, 11, −39, −1, 41, −14, 8, −2}. For a purpose of calculating a horizontal gradient value gradXMatrixI0[0] [0] of the pixel P00, the filter 125 can be utilized for calculation as follows:

gradXMatrixI0[0][0]=(−4)*R0+11*R1+(−39)*R2+(−1)*P00+41*P01+(−14)*P02+8*P03+(−2)*P04;

and for a purpose of calculating a horizontal gradient value gradXMatrixI0[0] [3] of the pixel P03, the filter 125 can be utilized for calculation as follows:

gradXMatrixI0[0][3]=(−4)*P00+11*P01+(−39)*P02+(−1)*P03+41*PO4+(−14)*P05+8*P06+(−2)*P07.

In this embodiment, as the calculation of a horizontal gradient value of each pixel within the first cluster of the first block 210 merely needs to further extend three pixels {R0, R1, R2} leftward and further extend four pixels {P04, P05, P06, P07} rightward, only eleven pixels on the horizontal direction is needed for completing calculation of horizontal gradient values in a same row. Based on a similar calculation, a vertical gradient value of each pixel can be calculated through the filter 125, and the calculation of the vertical gradient value of each pixel within the first cluster also merely needs to further extend three pixels upward and further extend four pixels downward. As mentioned above, only pixel values of totally 11*11 pixels are required to be stored for completing the calculations of the horizontal gradient values and the vertical gradient values, so hardware costs of the buffer 126 can be effectively reduced.

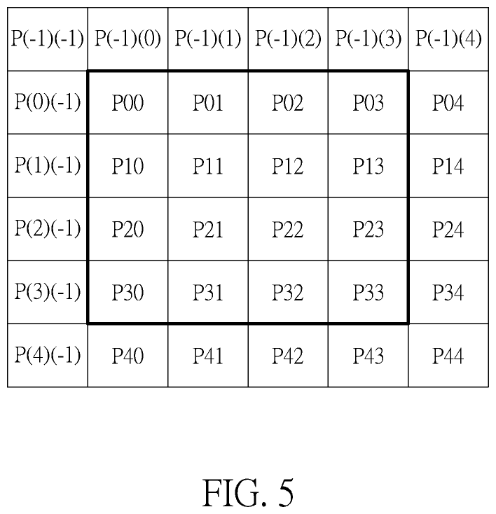

In the above embodiments, the filter 125 merely calculates gradient values of the pixels P00 to P33 within the first cluster. In another embodiment, however, for a purpose of increasing accuracy, a window can be additionally added in the first cluster comprising the pixels P00 to P33, and a window size of the window may be “one”, i.e. pixels P (−1) (−1) to P (−1) (4), P(0) (−1), P04, P(1) (−1), P14, P (2) (−1), P24, P (3) (−1), P34, P (4) (−1) to P44 are additionally added as shown in FIG. 5, and the filter 125 may perform the gradient calculations on the first cluster and 6*6 pixels within the window, to generate a horizontal gradient value and a vertical gradient value of each pixel within the pixels P (−1) (−1) to P44. In one embodiment, for a purpose of reducing the hardware costs of the buffer 126, the tap count of the filter 125 is “six,”, and the tap coefficients of the filter 125 may be {9, −40, −2, 41, −15, 7}, so only the pixel values of totally 11*11 pixels are required to be stored for completing the calculations of the horizontal gradient values and the vertical gradient values.

Similarly, the filter 125 within the adjustment value calculating circuit 124 also sequentially perform the gradient calculations of each pixel value within the second block 220 to generate a horizontal gradient value and a vertical gradient value of each pixel.

After determining the horizontal gradient value and the vertical gradient value of each pixel of the first cluster of the first block 210 and the second block 220, or after determining the horizontal gradient value and the vertical gradient value of each pixel of the first cluster and the window, the adjustment value calculating circuit 124 may use the following equations to calculate the adjustment value of the first cluster:

$$\begin{matrix}tx = gradXMatrixI 0 [ x ] [ y ] + gradXMatrixI 1 [ x ] [ y ] ; & ( 1 ) \\ ty = gradYMatrixI 0 [ x ] [ y ] + gradYMatrixI 1 [ x ] [ y ] ; & ( 2 ) \\ t = predMatrixI 1 [ x ] [ y ] - predMatrixI 0 [ x ] [ y ] ; & ( 3 ) \\ s 1 [ x ] [ y ] = {tx}^{*} tx ; & ( 4 ) \\ s 1 a = {\sum }_{( x , y ) ∈ ( 0 , 6 )} s 1 ( x , y ) ; & ( 5 ) \\ s 2 [ x ] [ y ] = {tx}^{*} ty ; & ( 6 ) \\ s 2 a = {\sum }_{( x , y ) ∈ ( 0 , 6 )} s 2 ( x , y ) ; & ( 7 ) \\ s 3 [ x ] [ y ] = - {tx}^{*} t ; & ( 8 ) \\ s 3 a = {\sum }_{( x , y ) ∈ ( 0 , 6 )} s 3 ( x , y ) ; & ( 9 ) \\ s 5 [ x ] [ y ] = {ty}^{*} ty ; & ( 10 ) \\ s 5 a = {\sum }_{( x , y ) ∈ ( 0 , 6 )} s 5 ( x , y ) ; & ( 11 ) \\ s 6 [ x ] [ y ] = - {ty}^{*} t ; & ( 12 ) \\ s 6 a = {\sum }_{( x , y ) ∈ ( 0 , 6 )} s 6 ( x , y ) ; & ( 13 )\end{matrix}$$

where in the above equations, gradXMatrixI0[x] [y] is a horizontal gradient value of a pixel P(x)(y) within the first block 210, gradYMatrixI0[x] [y] is a vertical gradient value of the pixel P (x) (y) within the first block 210, gradXMatrixI1[x] [y] is a horizontal gradient value of a pixel P(x)(y) within the second block 220, gradYMatrixI1[x] [y] is a vertical gradient value of the pixel P (x) (y) within the second block 220, predXMatrixI0[x] [y] is a pixel value (e.g. brightness value) of the pixel P(x)(y) within the first block 210, and predXMatrixI1[x] [y] is a pixel value (e.g. brightness value) of the pixel P(x)(y) within the second block 220. The adjustment value calculating circuit 124 then calculates coefficients vx and vy as follows:

vx=(s1a+r)>m?clip3(−thBIO,thBIO,((s3a<<5)/(s1a+r))):0 (14);

vy=(s5a+r)>m?clip3(−thBIO,thBIO,((s6a<<6)−vx*s2a)/((s5a+r)<<1))):0 (15);

where in the above equations, “r” and “m” are predetermined numbers, “−thBIO” and “thBIO” are boundary values of the clip operator; “«” is a bit shift left operator, “»” is a bit shift right operator; “?” and “:” are condition operators;
and afterward, the adjustment value calculating circuit 124 may calculate an adjustment value b as follows:

$$b = ( vx ( \frac{\partial I 1 ( x , y )}{\partial x} - \frac{\partial I 0 ( x , y )}{\partial x} ) + vy ( \frac{\partial I 1 ( x , y )}{\partial y} - \frac{\partial I 0 ( x , y )}{\partial y} ) + 32 ) \text{>>} 6. \qquad ( 16 )$$

After determining the adjustment value b, the pixel value calculating circuit 128 may refer to the pixel value of the pixel of the first block, the pixel value of the pixel of the second block and the adjustment value b to calculate a pixel value of the pixel of the current block 202. For example, a pixel value predBIO(x,y) of a pixel P(x) (y) of the current block 202 may be calculated as follows:

predBIO(x,y)=(predMatrixI0(x,y)+predMatrixI1(x,y)+b+1)>>1 (17);

where for each pixel within any cluster of the current block 202 (e.g. the pixels P00 to P33 within the first cluster), the same adjustment value b is utilized to calculate a corresponding pixel value of each pixel within this cluster.

Finally, the quantization and entropy encoding unit 129 perform operations on contents of the first frame I0, the current frame I and the second frame I1, to generate the encoded image data to the output circuit 130. As the operations of the quantization and entropy encoding unit 129 are well known for those skilled in this art, related details are omitted for brevity.

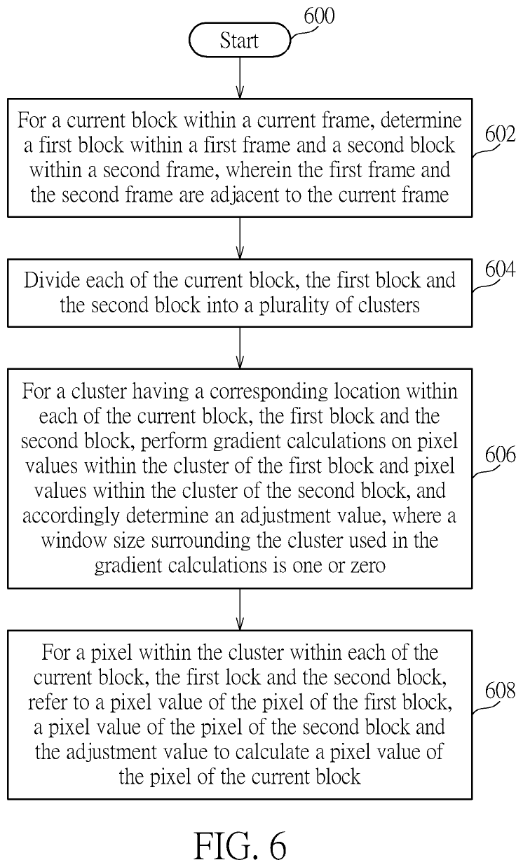

FIG. 6 is a flowchart illustrating an image processing method according to an embodiment of the present invention. Referring to the descriptions provided by the above embodiments, the flow of the image processing method is as follows.

Step 600: the flow starts.

Step 602: fora current block within a current frame, determine a first block within a first frame and a second block within a second frame, wherein the first frame and the second frame are adjacent to the current frame.

Step 604: divide each of the current block, the first block and the second block into a plurality of clusters.

Step 606: fora cluster having a corresponding location within each of the current block, the first block and the second block, perform gradient calculations on pixel values within the cluster of the first block and pixel values within the cluster of the second block, and accordingly determine an adjustment value, where a window size surrounding the cluster used in the gradient calculations is one or zero.

Step 608: for a pixel within the cluster within each of the current block, the first block and the second block, refer to a pixel value of the pixel of the first block, a pixel value of the pixel of the second block and the adjustment value to calculate a pixel value of the pixel of the current block.

Those skilled in the art will readily observe that numerous modifications and alterations of the device and method may be made while retaining the teachings of the invention. Accordingly, the above disclosure should be construed as limited only by the metes and bounds of the appended claims.

1. An image processing method, comprising:
for a current block within a current frame, determining a first block within a first frame and a second block within a second frame, wherein the first frame and the second frame are adjacent to the current frame;
dividing each of the current block, the first block and the second block into a plurality of clusters;
for a cluster having a corresponding location within each of the current block, the first block and the second block, performing gradient calculations on pixel values within the cluster and a window surrounding the cluster of the first block and pixel values within the cluster and the window surrounding the cluster of the second block so that each pixel within the window and the cluster has a gradient value, and accordingly determining an adjustment value, wherein a window size of the window surrounding the cluster used in the gradient calculations is one; and
for a pixel within the cluster within each of the current block, the first block and the second block, referring to a pixel value of the pixel of the first block, a pixel value of the pixel of the second block and the adjustment value to calculate a pixel value of the pixel of the current block.

2-5. (canceled)

6. The image processing method of claim 1, wherein a size of the cluster is 4*4 pixels.

7. The image processing method of claim 6, wherein a size of each of the current block, the first block and the second block is 4M*4N pixels, and each of the current block, the first block and the second block comprises M*N clusters, wherein the M and N are positive integer.

8. The image processing method of claim 6, wherein a tap count of a filter used in the gradient calculations is six.

9. The image processing method of claim 8, wherein a size of each of the current block, the first block and the second block is 4M*4N pixels, and each of the current block, the first block and the second block comprises M*N clusters, wherein the M and N are positive integer.

10. The image processing method of claim 1, wherein for each pixel within the cluster of the current block, using a same adjustment value to calculate a pixel value corresponding to said each pixel within the cluster.

11. An encoder, comprising:
a receiving circuit, configured to receive a first frame and a second frame;
an adjustment value calculating circuit, wherein for a current block within a current frame, the adjustment value calculating circuit determines a first block within the first frame and a second block within the second frame, and divides each of the current block, the first block and the second block into a plurality of clusters, wherein the first frame and the second frame are adjacent to the current frame; and for a cluster having a corresponding location within each of the current block, the first block and the second block, the adjustment value calculating circuit performs gradient calculations on pixel values within the cluster and a window surrounding the cluster of the first block and pixel values within the cluster and the window surrounding the cluster of the second block so that each pixel within the window and the cluster has a gradient value, and accordingly determines an adjustment value, wherein a window size of the window surrounding the cluster used in the gradient calculations is one; and
a pixel value calculating circuit, wherein for a pixel within the cluster within each of the current block, the first block and the second block, the pixel value calculating circuit refers to a pixel value of the pixel of the first block, a pixel value of the pixel of the second block and the adjustment value to calculate a pixel value of the pixel of the current block.

12-15. (canceled)

16. The encoder of claim 11, wherein a size of the cluster is 4*4 pixels.

17. The encoder of claim 16, wherein a size of each of the current block, the first block and the second block is 4M*4N pixels, and each of the current block, the first block and the second block comprises M*N clusters, wherein the M and N are positive integer.

18. The encoder of claim 16, wherein the adjustment value calculating circuit further comprises a filter, and a tap count of the filter used in the gradient calculations is six.

19. The encoder of claim 18, wherein a size of each of the current block, the first block and the second block is 4M*4N pixels, and each of the current block, the first block and the second block comprises M*N clusters, wherein the M and N are positive integer.

20. The encoder of claim 11, wherein for each pixel within the cluster of the current block, the pixel value calculating circuit uses a same adjustment value to calculate a pixel value corresponding to said each pixel within the cluster.
